(19) United States
(12) Patent Application Publication
(10) Pub. No.: US 2016/0267479 A1
(43) Pub. Date: Sep. 15, 2016

(54) Operation and Management System for Transaction Certificates

(71) Applicant: Pin-Ta Chung, Taichung City (TW)

(72) Inventor: Pin-Ta Chung, Taichung City (TW)

(21) Appl. No.: 15/032,930

(22) PCT Filed: Oct. 30, 2013
(86) PCT No.: PCT/CN2013/086199

§ 371 Date: Apr. 28, 2016

(51) Int. Cl. G06Q 20/38; G06Q 20/40

(52) U.S. Cl. CPC G06Q 20/38215; G06Q 20/401

(57) ABSTRACT

An operation and management system for transaction certificates comprises at least a transaction confirmation device, at least a relay setting device and a back-end management platform, wherein the relay setting device is connected between the transaction confirmation device and the back-end management platform. The relay setting device may set up the category of the transaction certificate to be issued in accordance with the type of the transaction confirmation device, generate data for the transaction certificate to be issued through the transaction confirmation device, and issue the intended transaction certificate. In addition, the back-end management platform may design the templates for different categories of transaction certificates, and regularly and automatically update the transaction certificate templates in the relay setting device. Therefore, no matter what type of the transaction confirmation device may be, it is possible to issue the transaction certificate on a variety of demands simply by operating conjunctively with the relay setting device and the back-end management platform.

### BACKGROUND OF THE INVENTION

1. Field of the Invention

The present invention generally relates to an operation and management system for transaction certificates; in particular, it relates to an architecture which is capable of issuing any kind of transaction certificates with the original equipments simply by connecting a relay device linked to the back-end management platform without altering the original equipments.

2. Description of Related Art

In general, it is required to issue transaction certificates (e.g., invoices, receipts, withholding certificates, commercial bills/papers and other relevant tickets/documents) for common transactions, which can be applied as an approach of trade verifications or evidences with regard to government taxations, billing or accounting procedures and business trades of both parties. Private companies can utilize the government-approved certificate templates as certificates for tax reports on the cash flows of in-bound and out-bound merchandise movements as well as various payments or other expenses, or otherwise acting as the base for subsequent payments and miscellaneous validations, while the government can also employ such a mechanism as the foundation for tax auditing in order to increase national treasury revenues.

Among such, invoices are the most common sales transaction certificates, and currently, issuing an invoice may be executed by printing a paper-based “Legal Invoice” consisting of 2 or 3 copies with a cashier/POS, in which one can be retained by the consumer, and the other one(s) can be held by the company or store thus later submitting to the government unit as the transaction proof for tax audits. Meanwhile, so-called electronic invoices indicate a type of business operation system that a seller may operate a computer to transfer the Uniform Invoice to a buyer via the Internet. In the processes of currently implemented electronic invoice operations, the seller issuing the electronic invoice may print out the stub copy, the buyer may have a printed version of the receipt copy, and both parties may download and save relevant files for future reference. But, in most cases, other transaction certificates (such as withholding certificates, receipts, bank transfer orders and other trade documents etc.) are so far still issued in paper-based hard copies, which means that the objectives of version control (maintenance and administration), environmental friendliness, information streaming and availability are quite difficult to achieve.

It should be known that, however, no matter the legally regulated transaction certificates or commercial transaction certificates customized by other business operators, the issued templates may vary due to relevant laws or customized rules, or even the introductions of certificates having different forms (e.g., receipts, financial notes and other papers), which could force the operators to inevitably modify the system architecture of the original equipments thereby fulfilling such new regulations, not to mention that the transaction certificate (invoice) templates and laws made by different countries may even differ. As a result, it would be required to alter the configurations of the needed equipments and software necessary for management and usage based on the changes in terms of regulations and forms or otherwise according to the new transaction certificates introduced from new trade patterns, and any of such modifications could undesirably cause significant troubles and costs for those business operators needing to introduce or update the certificate (invoice) templates and rules. Furthermore, with regard to certain multinational enterprises, typically different transaction certificate (invoice) templates and rules are utilized in different areas and different countries, and the equipment configurations and management methods may vary as well, or sometimes even the built-in software applications have to be largely changed so as to comply with local requirements, all of which could possibly indicate a huge amount of expenses for enterprises.

Consequently, it would be an optimal solution suppose it is possible, without altering the main structure of original equipments, to merely utilize the connection of a relay device linked to a back-end management platform in order to expand the features of the original equipments by allowing to issue any kind of transaction certificates, further capable of designing and automatically updating the certificate (or invoice) templates via the back-end management platform, and also satisfying the requirements on the consistence (e.g., regarding to legal certificates) and the differentiation (e.g., regarding to commercial certificates) among different certificate properties, thereby efficiently achieving the ultimate goals of transaction certificate electronization as well as extended applications thereof.

### SUMMARY OF THE INVENTION

The present invention provides an operation and management system for transaction certificates which, so long as the original equipments can generate required information, needs only to connect a relay device linked to the back-end management platform thus expanding the features of the original equipments by allowing to issue any kind of transaction certificates, without modifying the main structure of the original equipments.

An operation and management system for transaction certificates capable of achieving the aforementioned objectives comprises at least a transaction confirmation device, at least a relay setting device and a back-end management platform, wherein the transaction confirmation device is used to generate the data for the transaction certificate to be issued, and the transaction confirmation device includes at least a data generation module and an information input/output module connected to the data generation module; the relay setting device is connected to the transaction confirmation device and a back-end management platform and capable of receiving the data for the transaction certificate to be issued, in which the relay setting device includes an operation mode selection and matching module, used to determine the connection to the data generation module in the transaction confirmation device or other relay setting devices, set up the collaborative operation mode with the relay setting device, and return the setting contents to the back-end management platform thereby facilitating subsequent management operations; a transaction behavior and certificate selection module, used to select the related transaction behavior to which the relay setting device corresponds as well as the transaction certificate allowable to be issued; a central processing module, connected to the data generation module and the information input/output module of the transaction confirmation device as well as the operation mode selection and matching module, in which the transaction confirmation device performs data inquiries and data verifications through the central processing module and inputs the data for the transaction certificate to be issued to the central processing module; a certificate template management module, connected to the transaction behavior and certificate selection module and the central processing module, which is capable of receiving the certificate information set up by the back-end management platform and performing corresponding transaction certificate selections based on the data of the to-be-issued transaction certificate transferred by the central processing module; a certificate rule and data verification module, connected to the certificate template management module, which is capable of receiving the certificate information set up by the back-end management platform and performing data correctness verifications on the data of the to-be-issued transaction certificate transferred by the certificate template management module; a certificate issuing module, connected to the certificate rule and data verification module, which is capable of receiving the certificate information set up by the back-end management platform and using the data of the to-be-issued transaction certificate having confirmed correctness and transferred by the certificate rule and data verification module so as to perform the transaction certificate issuing operation in accordance with the certificate information and the data of the to-be-issued transaction certificate; a data storage module, connected to the central processing module, the certificate issuing module and the signature encryption module for storing the information after issuing the transaction certificate, in which the central processing module further transfers the information after issuing the transaction certificate to the transaction confirmation device or the information input/output module, other relay setting devices and the back-end management platform.

In addition, the back-end management platform connected to the relay setting device includes an operation management module, connected to the operation mode selection and matching module and the transaction behavior and certificate selection module of the relay setting device, which is capable of controlling the relay setting device and setting up and verifying the operation mode of the relay setting device via the operation mode selection and matching module, and further appointing the relay setting device to perform the corresponding transaction behaviors; a kernel information management module, connected to the operation management module thereby administrating any processing programs on the back-end management platform; a certificate template management and release module, connected to the kernel information management module as well as the certificate template management module, the certificate rule and data verification module and the certificate issuing module of the relay setting device, which is used to design the transaction certificate templates, the issuing rules, the rules for transaction certificate version management and the correspondences for data field bits in the data of the to-be-issued transaction certificate; and a certificate information storage module, connected to the kernel information management module and the central processing module of the relay setting device, which is used to upload and store the data generated by the relay setting device to the certificate information storage module and subsequently return the stored data to the relay setting device on demands thereby performing following verification behaviors.

More specifically, the data generation module of the aforementioned transaction confirmation device may be a computer, a cashier/POS, a mobile/hand-held electronic device or any other equipment capable of generating transaction information.

More specifically, the information input/output module of the aforementioned transaction confirmation device may be a keyboard, a card reader, a near-field wireless communication device, a display, a printer, a touchscreen, a scanner or any other equipment capable of conveniently generating information and presenting information.

More specifically, the operation mode of the relay setting device configured by the operation mode selection and matching module of the aforementioned relay setting device may be the stand-along operation of a single machine, the collaborative operation of multiple machines or else the connective operation with other information devices.

More specifically, the certificate information set up by the back-end management platform and received by the aforementioned certificate template management module includes the transaction behavior definition, the transaction certificate template, the certificate version management and the certificate effectiveness rule management.

More specifically, the certificate information set up by the back-end management platform and received by the aforementioned certificate rule and data verification module includes the verification rules for the correctness of data in the issued certificate.

More specifically, the certificate information set up by the back-end management platform and received by the aforementioned certificate issuing module includes the certificate issuing rules and the transaction certificate templates.

More specifically, the aforementioned certificate template management and release module includes a behavior definition setting module, a certificate rule design module, a certificate version management module and a certificate rule verification module.

More specifically, the aforementioned behavior definition setting module sets up relevant definitions and codes for a variety of transaction behaviors.

More specifically, the aforementioned certificate rule design module designs the certificate rules for a variety of electronic transaction certificates, designs the correspondences of the data field bits and builds the transaction certificate templates.

More specifically, the aforementioned certificate version management module converts the transaction certificate templates based on the changes in the data field bits for the certificate of a newer version and sets up the effective and sustainable dates for the certificate of the newer version thereby that, upon dispatching to the relay setting device, the relay setting device can automatically convert the transaction certificate template in accordance with the setting.

More specifically, the aforementioned certificate rule verification module sets up the certificate issuing rules, the verification rules for the correctness of the data in the issued certificate as well as the verification specifications for subsequent transaction certificate confirmations.

More specifically, the aforementioned back-end management platform further includes a signature encryption management and release module connected to the kernel information management module thereby facilitating management and distributions with regard to the effectiveness of the electronic signature certificate and performing designs, management and distributions for the data transmission encryption approaches.

More specifically, the aforementioned relay setting device further includes a signature encryption module connected to the signature encryption management and release module as well as the central processing module and the data storage module of the relay setting device, which is used to receive the signature encryption approach and rule set up by the signature encryption management and release module in order to perform the required signature actions appointed by the transaction certificate issuing rule, or the required signature verification actions upon collating transaction certificates, and selects and processes the encryption method of data transmissions.

### BRIEF DESCRIPTION OF THE DRAWINGS

FIG. 1 shows an integral architectural view of the operation and management system for transaction certificates according to the present invention.

FIG. 2 shows an architectural view of the relay setting device in the operation and management system for transaction certificates according to the present invention.

FIG. 3 shows an architectural view of the back-end management platform in the operation and management system for transaction certificates according to the present invention.

FIG. 4A shows a view for a setting example of the operation mode in the operation and management system for transaction certificates according to the present invention.

FIG. 4B shows a view for a setting example of the behavior definition in the operation and management system for transaction certificates according to the present invention.

FIG. 4C shows a view for a setting example of the legal certificate template management in the operation and management system for transaction certificates according to the present invention.

FIG. 4D shows a view for a setting example of a vendor's commercial certificate template management in the operation and management system for transaction certificates according to the present invention.

FIG. 5 shows an application architectural view for an embodiment of the operation and management system for transaction certificates according to the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

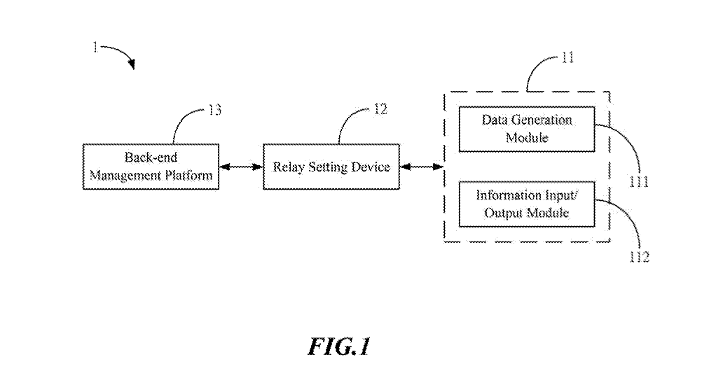

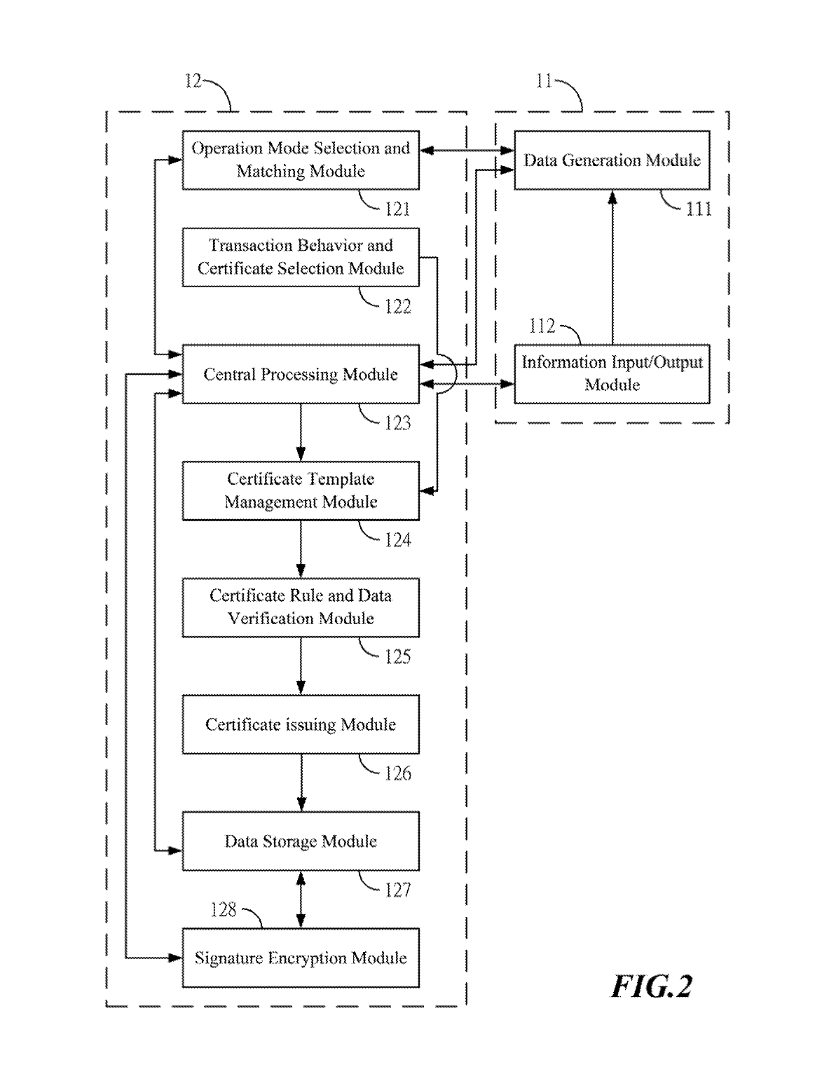

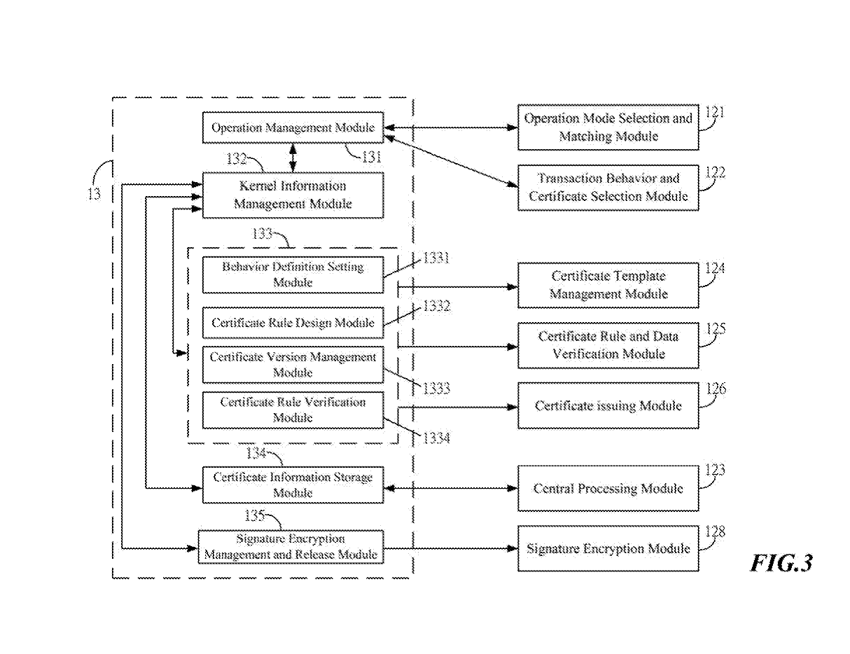

Refer initially to FIGS. 1, 2 and 3, wherein an integral architectural view, an architectural view of the relay setting device as well as an architectural view of the back-end management platform in the operation and management system for transaction certificates according to the present invention are respectively shown. It can be appreciated from the Figures that the operation and management system for transaction certificates 1 comprises at least a transaction confirmation device 11, at least a relay setting device 12 and a back-end management platform 13, in which the transaction confirmation device 11 includes a data generation module 111 or an information input/output module 112. Herein the data generation module 111 may be a computer (e.g., a personal computer (PC) or a notebook computer (NB)), a cashier/POS or a mobile/hand-held electronic device or any other equipments capable of generating transaction information, while the information input/output module 112 may be a keyboard, a card reader, a near-field wireless communication device, a display, a printer, a scanner or any other equipments capable of conveniently generating information and presenting information. Therefore, after having accessed the data via the information input/output module 112, it is possible to transfer to the data generation module 111, and then the data generation module 111 further sends the information into the relay setting device 12, herein the information input/output module 112 may also directly and interactively communicate the data with the relay setting device 12 on demands. Hence, it can be understood that the transaction confirmation device 11 essentially operates for data generations, subsequent certificate data returns (for the transaction certificate issuer and receiver), or data presentations on any other terminal equipments interfacing with the relay setting device 12.

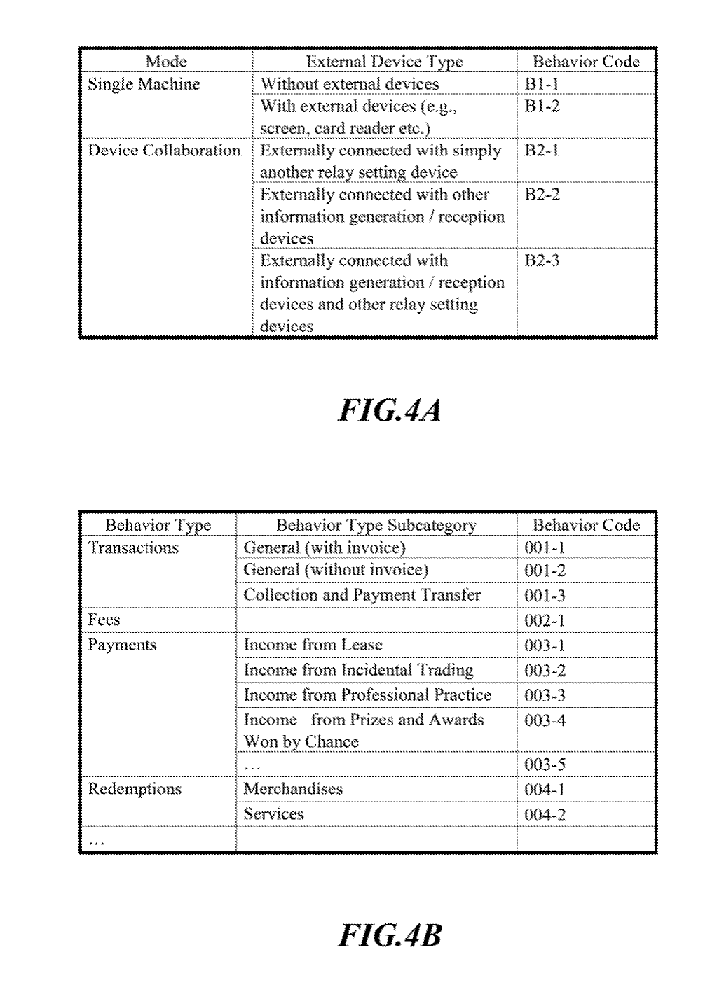

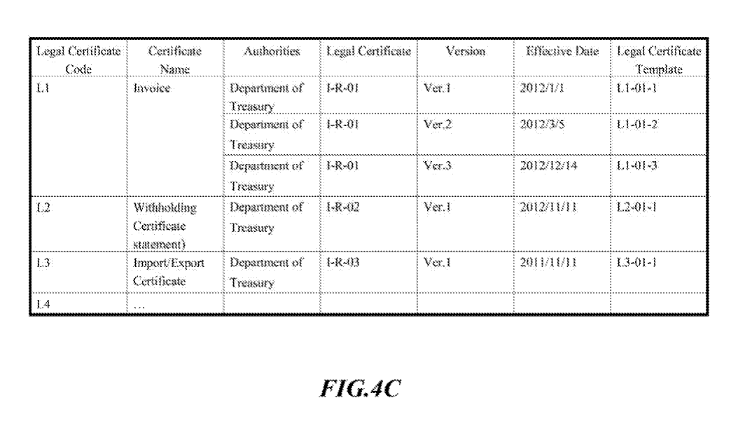

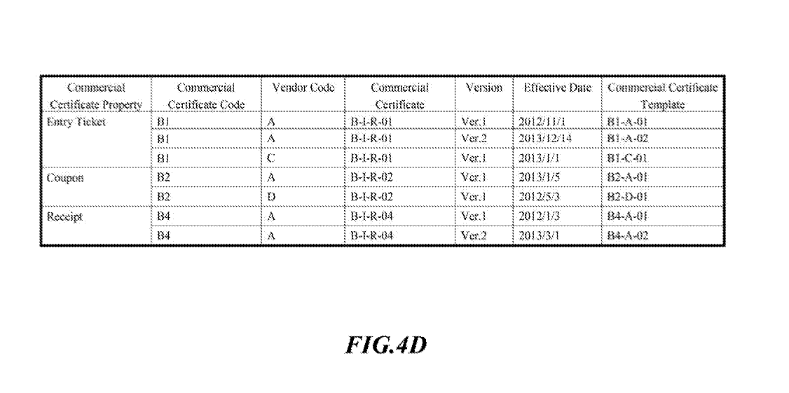

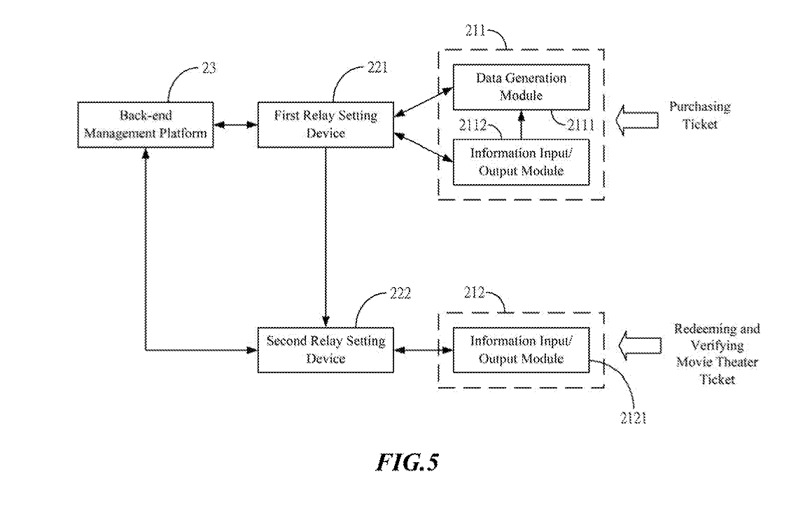

Meanwhile, the back-end management platform 13 includes an operation management module 131, a kernel information management module 132, a certificate template management and release module 133, a certificate information storage module 134 and a signature encryption management and release module 135, in which the operation management module 131 is configured essentially for ensuring the security of the relay setting device 12 thus preventing larcenies by malicious persons from illegally issuing certificates. As such, the operation management module 131 can be applied to control and administer the relay setting device 12 (by managing the ID of the relay setting device 12 and the interfacing mode), and to set up and verify the operation mode in the relay setting device 12 through the operation mode selection and matching module 121). Herein the operation mode may be the stand-along operation of a single machine, the collaborative operation of multiple machines or else the connective operation with other information devices. FIG. 4A shows a configuration example for the I/O operation mode of the device, categorizing the operation mode thereof into the “single machine stand-alone operation” as well as the “multiple machines collaborative operation”, and also further assorting and differentiating by means of device mode codes. Moreover, the operation management module 131 can assign the relay setting device 12 to correspond to the transaction behaviors thereby restricting the certificates that the relay setting device 12 is allowed to select and issue, limiting whether the relay setting device 12 is allowed to issue the certificate, or otherwise merely enabled to the use of transaction certificate data verifications and synchronizations.

Additionally, the kernel information management module 132 in the back-end management platform 13 indicates the information management center of the back-end management platform 13 thereby administrating any process programs on the back-end management platform 13 so that the kernel information management module 132 can be connected to the operation management module 131 (for equipment management), the certificate template management and release module 133 (for certificate template and rule management), the certificate information storage module 134 (for certificate information management) and the signature encryption management and release module 135 (for data security management).

Besides, the certificate information storage module 134 can be used to upload the data generated by the relay setting device 12 to the certificate information storage module 134, while the signature encryption management and release module 135 is in charge of supervising and distributing the effectiveness of electronic signature certificates, and also capable of designing, managing and dispatching the data transmission encryption methods.

The certificate template management and release module 133 in the back-end management platform 13 can be applied to design a variety of transaction certificate templates (including legally regulated, commercial or personal transaction certificates etc.), certificate versioning rules, settings for certificate issuance and verification rules, correspondences for data field bits in the data of the to-be-issued transaction certificates, certificate version management and certificate effectiveness rule management, and also configuration related version management and distributions or the like. Accordingly, the platform service provider may offer the transaction certificate templates and the transaction certificate issuers can perform the design works; meanwhile, the certificate template management and release module 133 includes a behavior definition setting module 1331, a certificate rule design module 1332, a certificate version management module 1333 and a certificate rule verification module 1334.

Herein the behavior definition setting module 1331 is able to configure relevant definitions and codes for various trade behaviors thereby facilitating correspondences to involved transaction certificate templates; as shown in FIG. 4B, an example for behavior definition settings illustrates that the behaviors can be classified into TRANSACTIONS, FEES, PAYMENTS and REDEMPTIONS which can be further sub-categorized based on behavior types and differentiated by means of behavior codes.

Moreover, the certificate rule verification module 1334 can build the certificate issuing rules and the verification rules for checking the correctness in the data of the issued certificate, and since the certificate issuance follows the certificate issuing rules, it is possible, upon externally connecting to an information generation device, to prevent errors in the introduced information created by the external device (the transaction confirmation device 11, for example), which may undesirably lead to certificate issuance errors.

Furthermore, herein the design certificate rule module 1332 allows to design certificate rules with regard to a variety of electronic transaction certificates, design correspondences of data field bits and construct transaction certificate templates, so the applications of the certificate rule design module 1332 may mainly cover the configurations of transmission MIG, template printing, other data generation rules (e.g., code assignments) and so on regarding to various electronic transaction certificates. For example, the invoice may have specifically regulated fields (e.g., invoice number, items, amounts, quantities, . . . , etc.), numbering rules (such as the regulations of number assignment published by the Department of Treasury), and printing templates or commercial redemption bills may also have similar or other customized fields thereof (such as seat number, performance session number etc.); in addition, the certificate version management module 1333 can convert the transaction certificate templates according to the changes of the data field bits in the certificate of newer version, and set up the effective and sustainable dates for the certificate of newer version so as to, upon distributing to the relay setting device 12, the relay setting device 12 can convert the transaction certificate template automatically based on the configuration, and since the transaction certificate may be modified, it could be necessary to convert the transaction certificate templates in accordance with such changes in the corresponding field bits and set up the effective and sustainable dates for the certificate of newer version (the sustainable date indicates that, before the certificate template is going to reaching the expired date, the device is allowed to connect to the back-end management platform 13 for inquiries and demand certificate template updates to the memory of the device) such that the device can automatically convert relevant certificate templates based on the setting data upon sending to the relay setting device 12.

As shown in FIGS. 4C and 4D, FIG. 4C illustrates a diagram for designating the management of legally regulated certificate templates in Taiwan, while FIG. 4D a diagram for designating the management of commercial certificate templates in companies (company A, C, D). It can be appreciated from FIG. 4C that the legally regulated certificate templates suitable for different certificates (e.g., invoices, withholding certificates, import/export papers etc.) may all vary. Also, it can be seen from the Figure that the versions of these certificates may be updated so that the certificate version management module is necessary for such administration and management operations. In addition, as shown in FIG. 4D, since there might be more comprehensively different commercial certificates of various types, such as various sorts of entry tickets, coupons and receipts, and the commercial certificate templates created by different companies may vary as well, without the controls and management under the present system, the number of different commercial certificates or transaction certificates corresponding to different countries could be uncountable, and the management tasks thereof may be extremely complicated. Contrarily, through the present system, it is possible to effectively supervise and control any types of certificates by way of the back-end management platform according to the present invention.

It should be known that the transaction confirmation device 11 can transfer the data of the to-be-issued transaction certificate to the relay setting device 12 only through the relay setting device 12, and then the relay setting device 12 applies the certificate template configured by the back-end management platform 13 to issue the desired transaction certificate. Herein the relay setting device 12 includes an operation mode selection and matching module 121, a transaction behavior and certificate selection module 122, a central processing module 123, a certificate template management module 124, a certificate rule and data verification module 125, a certificate issuing module 126, a data storage module 127 and a signature encryption module 128, wherein the operation mode selection and matching module 121 can select the operation mode of the relay setting device 12 in accordance with the operation mode set up by the operation management module 131 through the data generation module 111 in the transaction confirmation device 11, and return the setting contents to the back-end management platform 13 thereby facilitating subsequent management processes (e.g., assigning specific collaborative equipments, restricting the selections of the transaction behaviors and relevant certificate issuances etc.); moreover, the transaction behavior and certificate selection module 122 can be connected to the kernel information management module 132 by way of the operation management module 131 in the back-end management platform 13 so as to choose related transaction behaviors to which the relay setting device 12 can correspond as well as the transaction certificates allowable to be issued, such are by no means limited to be managed remotely, but those administrators in possession of the relay setting device 12 can also select the transaction behaviors and available corresponding transaction certificates in off-line and non-network transmission approaches.

Meanwhile, the central processing module 123 is connected to the data generation module 111 and the information input/output module 112 of the transaction confirmation device 11 thereby that the transaction confirmation device 11 can perform data inquiries and data verifications through the central processing module 123 and also enter the data of the transaction certificate to be issued into the central processing module 123. Therefore, the central processing module 123 represents the main I/O processing module for the relay setting device 12 thus that, no matter by way of network transmissions or via interfacing and communications of other specific information devices, all processes have to go through the central processing module 123 for executions.

The certificate template management module 124 can receive the certificate templates, the version management and the certificate effectiveness rule management configured by the back-end management platform 13 (e.g., the MIG uploaded to platform, MIG between terminal equipments, printing templates etc.), and then perform corresponding transaction certificate selections based on the data of the transaction certificate to be issued. Seeing that, before issuing the transaction certificate, it is required to examine whether the received external data matches specific rules (for example, whether the issued invoices comply with tax amount calculation logics and specific information verifications; or whether the issued entertainment theater tickets are accompanied with specific performance session information with no errors found in carrier number rule examinations), the certificate rule and data verification module 125 can receive the certificate information (including the correctness verification rules for the data in the issued certificate) set up by the certificate rule verification module 1334 of the back-end management platform 13 and the data of the transaction certificate to be issued thereby confirming the data correctness of the transaction certificate to be issued.

The certificate issuing module 126 can receive the certificate issuing rules set up by the back-end management platform 13 and the data of the to-be-issued certificate having confirmed correctness, so, after the above-said data being verified to be error-free, it is possible to perform transaction certificate issuance in accordance with the certificate issuing rules and the data of the transaction certificate to be issued; meanwhile, the data storage module 127 can save the information for the transaction certificate issuing, and the central processing module 123 can further transfer such information after issuing the transaction certificate to the data generation module 111 in the transaction confirmation device 11 as well as the back-end management platform 13. Moreover, the signature encryption module 128 receives the signature encryption method and rules set up by the signature encryption management and release module 135 thereby performing required signature actions for certificate issuances, and then the signature can be returned to the data storage module 127 and the central processing module 123 to be applied as the encryption method selections and processes of the data transmissions.

In order to further clearly illustrate the technical contents of the present invention, an embodiment concerning entertainment tickets is provided hereunder. As shown in FIG. 5, after a company acquiring the relay setting devices 221, 222, it is possible to, based on their needs, configure them as single-machine operations or external transmission devices of other equipments (having specific functions rather than simply for the use of transmissions). For example, a movie theater company may obtain two relay setting devices (denoted as a first relay setting device 221 and a second relay setting device 222), in which the first relay setting device 221 is utilized at the cashier counter as a transaction certificate issuer, and the second relay setting device 222 installed at the ticket checking entry as a ticket examiner. To interface with the customized POS (i.e., the data generation module 2111 in the transaction confirmation device 211) of the company for issuing process fee invoices (i.e., the legally regulated transaction certificates) and movie theater tickets (i.e., the commercial transaction certificates), the code of the first relay setting device 221 is assigned to be B2-3; on the other hand, in order to designate the second relay setting device 222 to be simply a cooperative device with respect to the first relay setting device 221 in the terminal area, the code of the second relay setting device is assigned as B2-1.

After completing the assignments, the first relay setting device 221 and the second relay setting device 222 both return their device information (B2-3 and B2-1) to the back-end management platform 23 and reply relevant information about other cooperative relay setting devices (such as Machine ID, interface modes etc.) For example, the back-end management platform 23 may return the system information of the cooperative devices in the terminal area (i.e. the system information of the second relay setting device 222) to the first relay setting device 221 and, similarly, the system information of the cooperative devices (i.e. the system information of the first relay setting device 221) to the second relay setting device 222 thereby that the first relay setting device 221 and the second relay setting device 222 connect with each other for confirmations.

Afterwards, the relay setting devices 221, 222 can be assigned with corresponding transaction behaviors (in this example, the purchase behavior and the ticket issuing and redemption). For example, the back-end management platform 23 can additionally return to the first relay setting device 221 (by sending the codes 001-1, 001-2 and related messages) and to the second relay setting device 222 simply for redemption behavior (by sending the code 004-1 and related messages).

Following this, it is possible to restrict the allowable certificate issuances. For example, the back-end management platform 23 may set up the relationship between the behavior code and the corresponding certificate, wherein, in this example, the code 001-1 corresponds to the legal certificate I-R-01, the code 001-2 to the commercial certificate B-I-R-01, and the code 004-1 to the commercial certificate B-I-R-01. Also, the back-end management platform 23 may additionally return the currently (e.g., 2012/11/10) latest certificate templates to the first relay setting device 221 (by sending the codes L1-01-2, B1-A-01 and related messages) and to the second relay setting device 222 (by sending the code B1-A-01 and related messages). Such two types of codes along with relevant transaction behaviors can facilitate matching confirmations.

The aforementioned processes illustrate the programs concerning equipment configuration and management, and the subsequent descriptions set forth the two certificate templates for designing invoices and tickets and various rule settings as well as the templates, rule and effective dates for the two certificates, i.e., the invoice and the ticket, wherein the contents of the certificate template management includes, as below:

1. Designing the Certificate Templates of the Invoice and the Ticket

(a) with regard to government units or platform administrators, public templates may be designed and provided for selections. For example, the template L1-01-3 may include the behavior code (001-1), invoice information fields (e.g., carrier number, invoice number, issuing time, items, quantities, sales amounts, tax amounts, total amount etc.), invoice printing template (paper sizes and specifications, field bit layouts etc.), relevant number allocation rules (the first two tracks are alphabets, the later 8 digits are numbers), and the template represented by L2-01-1 may include the behavior code (e.g., 003-1), income information fields (such as carrier number etc.), withholding certificate printing field and withholding certificate number allocation rules.

(b) for customized commercial certificates, like the tickets exemplified as the B1-A-01, the template may include the behavior code (001-2), transaction contents field bits (e.g., carrier number, ticket number, issuing date, performance session, seat number etc.), ticket printing template (paper sizes, field layouts etc.), and related number allocation rules.

(c) Compliance with the information audit regulations about the designs of certificate issuances and audit operations, since each sort of legally regulated certificate has its respective audit rules, such as the invoice L1-01-3 regulates the Taiwan sales tax amount=sales amount*5%, and so forth. Analogously, each type of commercial certificates may also has its own respectively customized rules, such as the performance session and seat number on the ticket B1-A-01 should not be void, etc.

2. The Certificate Templates, Rules and Effective Dates of the Invoice and the Ticket

(a) In constructing the system, the company may configure related requirements (such as the template dispatch time) on the back-end management platform 23 and distribute the latest version thereof as well as miscellaneous rules (for example, downloading the legally regulated certificate invoice number allocations AA00000000˜AA99999999 and the commercial certificate ticket number allocations Z000˜Z999).

(b) The sustainable duration may be defined with respect to each version of certificate templates thus optionally allowing system shutdown so as to execute update operations thereby preventing the problems of outdated certificate templates and data due to long-term offline uses. For example, the sustainable duration for the invoice of the second version may span from the beginning to the end of a month, and examinations may be performed monthly during 2013/4˜12 to check out the release of new templates.

(c) In case of version variations in subsequent templates (e.g., the template concerning the invoice of third version is expected to be on-line on 2012/12/14), then the version dispatch will be performed within a period of time before the template effective date, and the system can automatically stand on the effective date and time in order to execute automatic template conversions (for example, automatically converting from the second version of the invoice to the third version thereof at 23:59:59 on 2012/12/13 and then using the new template to do the subsequent invoice issuances automatically).

The aforementioned processes describe the contents of the certificate template management, and the following paragraphs illustrate the processes of the transaction certificate generation according to the present embodiment, as below:

1. Reading identification code records;

2. Transferring basic behavior information;

3. Confirming behavior code and corresponding certificate template;

4. Confirming correctness of relevant certificate information;

5. Transferring relevant information and issuing relevant certificate;

6. Storing certificate-related information;

7. Performing certificate signature and encryption;

8. Returning data to transaction confirmation device and other relay setting devices and uploading to back-end management platform;

9. Saving data in other relay setting device.

In the present embodiment, a consumer initially takes an NFC mobile phone (carrier number A1B2C3) to the cashier counter for sensing and reading and purchases a movie theater ticket (with an extra 10 NT dollars process fee); herein the aforementioned behaviors may be categorized into the “purchase behavior” and the “ticket delivery”, so the information input/output module 2112 in the transaction confirmation device 211 can scan and read, then the information created by the data generation module 2111 (PC/NB/POS/Mobile Device/ . . . ) of the transaction confirmation device 211 can be transferred to the first relay setting device 221, in which the created information includes two transaction contents, respectively, the first transaction contents (comprising Carrier Number:A1B2C3, Behavior Code: 001-1, Date: 2013 May 1, Item: process fee, Quantity:1, Sales Amount: 10 NT dollars, Tax Amount: 1 NT dollar etc.) and the second transaction contents (comprising Carrier Number: A1B2C3, Behavior Code: 004-1, Date: 2013 May 1, Performance Session: 99, Seat: Row 2/No. 6).

Next, the behavior codes and corresponding certificate templates can be verified and the vendor can confirm the behavior types autonomously, and since the transferred data includes the behavior codes, the first relay setting device 221 can search for the relevant certificate template; for example, the legal certificate to which the setting 001-1 corresponds is I-R-01, and the corresponding newest certificate template thereof is L1-01-3, while the commercial certificate to which the setting 001-2 corresponds is B-I-R-01, and the corresponding newest certificate template thereof is B1-A-01. After confirming the behavior codes and corresponding certificate templates, it is possible to verify the correctness of relevant certificate information by, for example, examining whether the information verified and transferred by the relay setting device is correct so as to check whether the Tax Amount 1 NT dollar on the invoice is equal to the 5% of the Sales Amount 10 NT dollars, check whether the Performance Session and Seat on the ticket are not void, or the like.

In case that the aforementioned information verifications are successfully passed, the relevant information can be organized in the information sorting order required by the legal certificate template and transferred to the certificate issuing module, then the related certificates can be sequentially issued in accordance with the certificate data along with other certificate issuing rules (e.g., the number allocation rule). In the present embodiment, for example, invoices can be issued in which the contents in one of such certificates may include: Carrier Number: A1B2C3, Invoice Number: AA00000099, Behavior Code: 001-1, Date: 2013 May 1, Item: Process Fee, Quantity: 1, Sales Amount 10 NT dollars, Tax Amount: 1 NT dollar, and the other one may state: Carrier Number: A1B2C3, Ticket Number: Z555, Behavior Code: 004-1, Date: 2013 May 1, Performance Session: 99, Seat: Row 2/No. 6).

After having issued the certificates, the original information of the above-said issued certificates can be sent to the data storage module for saving, and, with the selected signature and encryption method on demand, the data can be returned to the data storage module, then also by way of the predetermined synchronization path, further returned to the second relay setting device 222 and the back-end management platform 23 for storage. In addition, it is possible as well to send the data to the data generation module 2111 in the transaction confirmation device 211 according to requirements; in the present embodiment, since the NFC mobile phone of the consumer is equipped with a storage module, the transaction confirmation device 211 may return relevant messages to the consumer. Furthermore, the second relay setting device 222 can also save the data for future examinations thereby preventing efficiency issues on real-time data inquiries (e.g. disconnected during inquiries) and for the purpose of data backup.

Finally, the transaction certificate can be verified, so that when the consumer holds the NFC mobile phone to sense and read out for ticket redemption to enter into the theater, the identification code information can be transferred and the second relay setting device 222 connects to the transaction confirmation device 212. In the present embodiment, the transaction confirmation device 212 connected to the second relay setting device 222 applies only the information input/output module 2121, i.e., a card reader, so it can determine the carrier number is A1B2C3 via the card reader; after reading, the process can start to inquire and confirm the redemption. In case the central processing module determines the carrier number specification is correct, then it reads the data storage module to see whether relevant information exists (if no data, then connecting to the first relay setting device and the back-end management platform for inquiries); however, suppose the data does exist (e.g., the Carrier Number: A1B2C3, Ticket Number: Z555, etc.) and related condition values are determined to be no error (for example, whether the time for the redemption session is correct), then it writes in the redemption notes (the redemption notes may include: Redeemed, Carrier Number: A1B2C3, Ticket Number: Z555) through the certificate issuing module and the signature and encryption module, then saving into the data storage module. Following this, the process returns the ticket status and synchronizes the ticket information, thus further synchronizing the aforementioned redemption information (i.e., Redeemed, Carrier Number: A1B2C3, Ticket Number: Z555) to the first relay setting device 221 and the certificate data storage module in the back-end management platform 23 so as to ensure the data integrity of the entire architecture and eliminate the occurrence of any inconsistence on the inquired data between the consumer, the vendor and the audit units (such as the government, accountants, etc.)

As such, in comparison with other conventional technologies, the operation and management system for transaction certificates according to the present invention provides the following advantages:

1. Without altering the main architecture of the original equipments, the present invention allows to, simply by connecting a relay setting device linked to the back-end management platform, utilize the original equipments to issue any types of transaction certificates and further update automatically the transaction certificate (invoice) templates through the back-end management platform.

2. For certain multi-national enterprises, due to differences in business ranges, areas, nations or the like, it may be necessary to use a variety of certificate (invoice) templates; hence, with the technologies provided by the present invention, such multi-national enterprises may not be required to adopt different equipment configurations and management methods to resolve such variations, but, instead, merely connecting the relay setting devices in order to comply with local regulations or demands by means of the settings on the back-end management platform, which indicates a significant advantage from the aspect of cost-saving.

Through the aforementioned detailed descriptions for the preferred embodiments of the present invention, it is intended to better illustrate the characteristics and spirit of the present invention rather than restricting the scope of the present invention to the preferred embodiments disclosed in the previous texts. On the contrary, the objective is to encompass all changes and effectively equivalent arrangements within the scope of the present invention as delineated in the following claims of the present invention.

What is claimed is:

1. An operation and management system for transaction certificates, characterized in comprising:
at least a transaction confirmation device, at least a relay setting device and a back-end management platform, wherein the transaction confirmation device is used to generate the data for the transaction certificate to be issued, and the transaction confirmation device includes at least a data generation module and an information input/output module connected to the data generation module;
the relay setting device is connected to the transaction confirmation device and the back-end management platform and capable of receiving the data for the transaction certificate to be issued, in which the relay setting device includes:
an operation mode selection and matching module, used to determine the connection to the data generation module in the transaction confirmation device or other relay setting devices, set up the collaborative operation mode with the relay setting device, and return the setting contents to the back-end management platform thereby facilitating subsequent management operations;
a transaction behavior and certificate selection module, used to select the related transaction behavior to which the relay setting device corresponds as well as the transaction certificate allowable to be issued;
a central processing module, connected to the data generation module and the information input/output module of the transaction confirmation device as well as the operation mode selection and matching module, in which the transaction confirmation device performs data inquiries and data verifications through the central processing module and inputs the data for the transaction certificate to be issued to the central processing module;
a certificate template management module, connected to the transaction behavior and certificate selection module and the central processing module, which is capable of receiving the certificate information set up by the back-end management platform and performing corresponding transaction certificate selections based on the data of the to-be-issued transaction certificate transferred by the central processing module;
a certificate rule and data verification module, connected to the certificate template management module, which is capable of receiving the certificate information set up by the back-end management platform and performing data correctness verifications on the data of the to-be-issued transaction certificate transferred by the certificate template management module;
a certificate issuing module, connected to the certificate rule and data verification module, which is capable of receiving the certificate information set up by the back-end management platform and using the data of the to-be-issued transaction certificate having confirmed correctness and transferred by the certificate rule and data verification module so as to perform the transaction certificate issuing operation in accordance with the certificate information and the data of the to-be-issued transaction certificate;
a data storage module, connected to the central processing module, the certificate issuing module and the signature encryption module for storing the information after issuing the transaction certificate, in which the central processing module further transfers the information after issuing the transaction certificate to the transaction confirmation device and the back-end management platform;
the back-end management platform, connected to the relay setting device, in which the back-end management platform includes:
an operation management module, connected to the operation mode selection and matching module and the transaction behavior and certificate selection module of the relay setting device, which is capable of controlling the relay setting device and setting up and verifying the operation mode of the relay setting device via the operation mode selection and matching module, and further appointing the relay setting device to perform the corresponding transaction behaviors;
a kernel information management module, connected to the operation management module thereby administrating any processing programs on the back-end management platform;
a certificate template management and release module, connected to the kernel information management module as well as the certificate template management module, the certificate rule and data verification module and the certificate issuing module of the relay setting device, which is used to design the transaction certificate templates, the issuing rules, the rules for transaction certificate version management and the correspondences for data field bits in the data of the to-be-issued transaction certificate; and
a certificate information storage module, connected to the kernel information management module and the central processing module of the relay setting device, which is used to upload and store the data generated by the relay setting device to the certificate information storage module and subsequently return the stored data to the relay setting device on demands.

2. The operation and management system for transaction certificates according to claim 1, characterized in that: the data generation module of the transaction confirmation device is a computer, a cashier/POS or a mobile/hand-held electronic device.

3. The operation and management system for transaction certificates according to claim 1, characterized in that: the information input/output module of the transaction confirmation device is a keyboard, a card reader, a near-field wireless communication device, a display, a printer or a scanner.

4. The operation and management system for transaction certificates according to claim 1, characterized in that: the operation mode of the relay setting device configured by the operation mode selection and matching module of the relay setting device is the stand-along operation of a single machine, the collaborative operation of multiple machines or else the connective operation with other information devices.

5. The operation and management system for transaction certificates according to claim 1, characterized in that: the certificate information set up by the back-end management platform and received by the certificate template management module includes the transaction behavior definition, the transaction certificate template, the certificate version management and the certificate effectiveness rule management.

6. The operation and management system for transaction certificates according to claim 1, characterized in that: the certificate information set up by the back-end management platform and received by the certificate rule and data verification module includes the verification rules for the correctness of data in the issued certificate.

7. The operation and management system for transaction certificates according to claim 1, characterized in that: the certificate information set up by the back-end management platform and received by the certificate issuing module includes the certificate issuing rules and the transaction certificate templates.

8. The operation and management system for transaction certificates according to claim 1, characterized in that: the certificate template management and release module includes a behavior definition setting module, a certificate rule design module, a certificate version management module and a certificate rule verification module.

9. The operation and management system for transaction certificates according to claim 8, wherein the behavior definition setting module sets up relevant definitions and codes for a variety of transaction behaviors.

10. The operation and management system for transaction certificates according to claim 8, characterized in that: the certificate rule design module designs the certificate rules for a variety of electronic transaction certificates, designs the correspondences of the data field bits and builds the transaction certificate templates.

11. The operation and management system for transaction certificates according to claim 8, characterized in that: the certificate version management module converts the transaction certificate templates based on the changes in the data field bits for the certificate of a newer version and sets up the effective and sustainable dates for the certificate of the newer version thereby that, upon dispatching to the relay setting device, the relay setting device can automatically convert the transaction certificate template in accordance with the setting.

12. The operation and management system for transaction certificates according to claim 8, characterized in that: the certificate rule verification module sets up the certificate issuing rules, the verification rules for the correctness of the data in the issued certificate as well as the verification specifications for subsequent transaction certificate confirmations.

13. The operation and management system for transaction certificates according to claim 1, characterized in that: the back-end management platform further includes a signature encryption management and release module connected to the kernel information management module thereby facilitating management and distributions with regard to the effectiveness of the electronic signature certificate and performing designs, management and distributions for the data transmission encryption approaches.

14. The operation and management system for transaction certificates according to claim 13, characterized in that: the relay setting device further includes a signature encryption module connected to the signature encryption management and release module as well as the central processing module and the data storage module of the relay setting device, which is used to receive the signature encryption approach and rule set up by the signature encryption management and release module in order to perform the required signature actions appointed by the transaction certificate issuing rule and selects and processes the encryption method of data transmissions.
